(19) United States
(12) Patent Application Publication
(10) Pub. No.: US 2022/0247861 A1
(43) Pub. Date: Aug. 4, 2022

(54) COOPERATIVE CONTACT LISTS

(71) Applicant: XCAST LABS, INC., Northfield, IL (US)

(72) Inventor: Vladimir SMELYANSKY, Glenview, IL (US)

(73) Assignee: XCAST LABS, INC., Northfield, IL (US)

(21) Appl. No.: 17/592,485

(22) Filed: Feb. 3, 2022

Related U.S. Application Data
(60) Provisional application No. 63/145,219, filed on Feb. 3, 2021.

(51) Int. Cl. H04M 3/436; G06F 21/62; H04M 1/2757

(52) U.S. Cl. CPC H04M 3/436; H04M 1/2757; G06F 21/62

(57) ABSTRACT

The present invention provides an effective means of screening calls by sharing contact data between individual users of communication devices. The contact information is augmented to include shareability data and relations data. The additional data can be used to configure the shared data in a way that private contacts, for example, can be restricted from sharing, while public contacts are shared.

### BACKGROUND OF THE INVENTION

### 1. Field of the Invention

The present invention relates generally to telecommunications, and more particularly, to preventing unwanted calls from reaching called parties, from callers who are undertaking unwanted marketing or solicitation efforts. These unwanted calls are commonly referred to as “robocalls,” and are often initiated overseas at large call centers. However, they can be any unwanted call, including “spoofed” calls where the caller ID identifies a caller with a number that does not correspond to the actual number of the caller, in an effort to have the called party pick up and initiate a conversation, unwanted by the called party.

### 2. Description of the Related Art

The U.S. Federal Communications Commission (FCC) and Federal Trade Commission (FTC) have website replete with information about robocalls and how consumers can make complaints and avoid receiving the calls. It is believed that more complaints are made to these federal agencies about robocalls than any other consumer complaint. Congress has been actively enacting legislation to punish illegal robocalling, and to force telecommunication companies to enact robocall mitigation technology.

In 2009, prerecorded commercial telemarketing calls to consumers were prohibited by the FTC, unless a telemarketer obtained permission in writing from consumers who want to receive such calls. This new FTC rule was part of an amendment to the agency's Telemarketing Sales Rule (TSR), whereby sellers and marketers who transmit prerecorded messages to consumers who had not agreed in writing to accept such messages would face penalties of up to $16,000 per call. The rule did not prohibit purely informational calls, such has flight information from airlines, delivery notifications for ordered products. Clearly, not all robocalls were deemed illegal or unwanted. No matter how well intended, the 2009 rule prompted illegal callers to adopt spoofing techniques, making it difficult or impossible to determine who was making the call, particularly where the caller is located overseas and/or where the calls is made from a difficult-to-trace computer.

The problem persisted in spite of the efforts of government agencies to create sanctions against the callers. In 2019, the FCC proposed new requirements for all voice providers, mobile, VOIP and landlines that would require them to install new technology to detect and block scam robocalls. In the same year, Congress passed the Telephone Robocall Abuse Criminal Enforcement and Deterrence Act, known by its acronym as the TRACED Act, to improve the fight against unwanted, and often illegal, robocalls—at the time and continuing to be the top complaint reported to the FCC annually.

In spite of all these rule and legislative enactments, robocalling continues to be a problem. Some efforts have proven to block too many calls, resulting in missed wanted calls, and some have not blocked enough calls, resulting in unwanted calls going through.

Currently many people keep their contacts from their phones by utilizing cloud services. A particularly popular cloud service for storing contacts is known commercially as “Google Contacts.” Presently available applications allow a user, meaning the owner of the phone, to access only that particular user's contacts from a contact list, or in some cases, to their employer's contact lists as can be implemented with an MS Exchange server. Usually, contacts associated with the user's phone are not identifiable as robocalls and calls coming from contact numbers are allowed to pass through to the user. Presently, it is not possible to share contacts lists with users on an owners contact list. The ability to use mutual contacts between two users presents an opportunity to enhance robocall mitigation simply and cost effectively.

A continuing need exists for a better, simple and effective way to screen or block robocalls.

### SUMMARY OF THE INVENTION

An object of the present invention is to allow users to share information between contact books for making calls, retrieving addresses, blocking calls as well as potentially using other information that could be added to the list.

To enable a user to share contact information and exchange data without violation of the privacy of the user, the present invention includes adding to each contact additional properties, which will describe the contact visibility.

The additional properties can be grouped into two categories. The first category is for describing the shareability of the contact. The properties can be as follows: private, family, friends, public. The second category is for describing relations to the contact. These properties can be as follows: family member, friend.

The present invention provides improved and more effective ways of preventing robocalls from reaching called parties who do not want them. In a particularly preferred embodiment, a method of preventing robocalls from reaching a called party when initiated by an unwanted or unauthorized calling party, comprising adding to each of a plurality of contact lists information indicating, for each entry in each contact list, information indicating a level of shareability of the entry with non-owners of the contact list based on relations of the owner of the contact list with the non-non-owners, and adding information indicating a relation of the entry with the owner of the contact list. Preferably, in response to a request for access to each entry of a contact list by a non-owner of the contact list, the method includes granting or restricting access to the contact list based on a relation of the owner to the non-owner requesting access and based on an indicated level of shareability of each entry.

In another aspect of the invention, an apparatus provides improved and more effective ways of preventing robocalls from reaching called parties who do not want them. In a particularly preferred embodiment, the apparatus includes means for preventing robocalls from reaching a called party when initiated by an unwanted or unauthorized calling party, comprising means for adding to each of a plurality of contact lists information indicating, for each entry in each contact list, information indicating a level of shareability of the entry with non-owners of the contact list based on relations of the owner of the contact list with the non-non-owners, and means for adding information indicating a relation of the entry with the owner of the contact list. Preferably, in response to a request for access to each entry of a contact list by a non-owner of the contact list, the apparatus includes means for granting or restricting access to the contact list based on a relation of the owner to the non-owner requesting access and based on an indicated level of shareability of each entry.

### BRIEF DESCRIPTION OF THE DRAWINGS

FIG. 1 is a graphical representation of a data structure according to a preferred embodiment of the present invention; and

FIG. 2 is a flow chart demonstrating how calls are treated when shared contacts are implemented with additional data is included;

### DETAILED DESCRIPTION OF THE INVENTION

In order to prevent unwanted robocalls from arriving at a called party, and to avoid screening or blocking wanted calls to a called party, additional properties are added to each contact within a user's contact data. For example, presently contact data includes name, phone number or numbers, address, job title and employer name. These are more or less generic data sets that do not normally come into play when deciding whether a call is wanted or unwanted. The present invention adds to the contact data information that controls to whom and what data can be shared. In a simple example, if a person A is in the contact data of person B, and a person C is in the contact data of person A but not in the contact data of person B, should person C call person B, that call will be considered “wanted” and thus not a robocall, simply because person C is a trusted contact of person A, who is in person B's contacts. This demonstrates the general idea behind sharing contacts.

With that in mind, it may be that person B will not want all of his or her contacts shared. For example, if person A receives a call from person C, who happens to be a hardware store, if the number of the person C hardware store is designated by person B to be public, it will be shared with person B; when numbers are shared, they will not be blocked. If on the other hand, person C is a private contact that person B does not want to share, the contact data can indicate that the contact is a “private” contact and thus the number will not be shared. In that way, if person C were to call person A, it would identify as an unknown number, given person A the option of screening the call. It could be set in data permissions that any number not in contacts is automatically screened, or blocked, or subject to additional verifications before the call goes through.

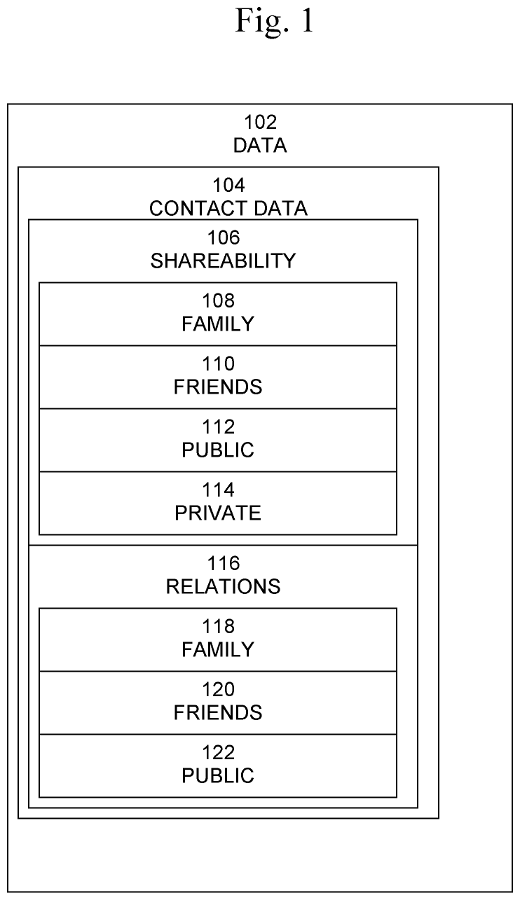

The additional properties added to each contact are those selected to preserve privacy while at the same allowing wanted calls and screening unwanted calls. Contact visibility will depend on the properties. The properties come in at least two different categories or layers of scrutiny. The first data addition is to define shareability of the contact, with a focus on the following designations: private, family, friends, public. As seen in FIG. 1, data 102 represents the basic contact data such as name and number. Contact data 104 represents what data is added to the basic data that defines the contact in a way that determines shareability 106. As noted, these data points include family 108, friends, 110, public 112, and private 114. These properties are named as stated, but could equally be represented numerically, such as number 1 is family, number 2 for friends, and so on. In setting up the data structure, a user can use either names or numbers to grant permissions.

As seen in FIG. 1, relations 116 are another additional data set to help determine shareability of contacts. The contact lists will be linked based on logic. For example, if a person A has a person B listed as a contact and both persons have contact lists, they will be linked to each other. For any user in the future, access can be granted to all contacts based on the following logic:

Family members—have access to all contacts that are shared/marked as family, friends and pubic.
Friends—have access to all contacts that are shared/marked as friends and public.
Public—have access to all contacts that are shared/marked as public.

If the person A in person B's contact list is marked as “family”, it means that person A is a family member and has family level access to the contacts in person B's list. That would allow the retrieval of all contacts marked as family, friends and public access levels.

If the person A in person B's contact list is marked as a “friend,” person A is a family member and has the friend's level of access. That would allow the retrieval of all contacts marked as friends and public.

If person A is not specially marked as either friend or family, only public contacts from person B's contact list will be provided.

Contacts marked as private will not be shareable whatsoever.

Contact retrieval works the follow ways. If person A asks for a contact, the list of all contacts that are found in the shared contact lists based on the restrictions described above should be provided. IT can be done in addition to public data that may or may not be provided as well.

Considering that someone could have thousands of contacts, the search for contacts could be extreme net wide. That should allow additional potential configurations, such as limiting search to family, or family and friends only.

Additional properties can be added to the original contact list, where those additional properties specify not to retrieve contacts from the list that belongs to a particular contact. For example, the contact is a company that has shareable contact lists and it could be a very large data file.

While data entries are typically manual, artificial intelligence (AI) can be used with or without other algorithms to order and/or limit the size of the retrieved list of contacts.

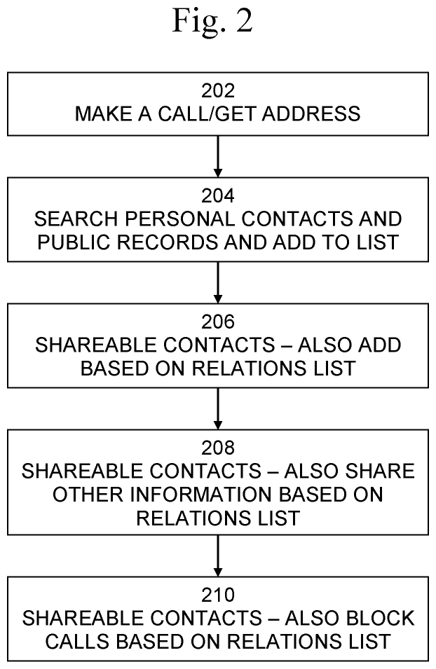

A description of how a user makes a call now follows, with reference to FIG. 2. When someone makes a call, the current strategy for robocall mitigation looks for the contacts in your personal contacts data and, in some cases, public records (white/yellow pages) and adds them to the list. When adding the sharable contacts, the lookup would be altered to add findings from the proper contact lists based on the relations between the caller and the third party's list. The contacts, with phone numbers, will be provided with the ability to call any of them.

When someone is looking for an address, the current strategy is to look for the contacts in personal contact book and, in some cases, public records (white/yellow pages) and add them to the list. With shareable contacts, the lookup would be altered to add findings from the proper contact lists based on the relations between requestor and the third party's list. The contacts, with addresses will be provided with the ability to select any of them.

To retrieve other information, contact lists can contain other information, such as, birthday and anniversary dates. Such information can be shared based on the same rules described above.

Contact sharing can be used to block unwanted calls. While there are many different strategies to block calls today, it is important to maintain privacy and avoid being overly scrutinous, to the point of blocking wanted calls. One strategy is to block all calls that are not from people designated “personal” in the contacts data. The problem that such a screen creates is that limiting incoming calls to personal contacts will block calls from doctors or car dealerships or libraries or some other third party including emergency services. While the advent of STIR/SHAKEN a caller phone number would become very reliable as an identifier of the caller, it would still be up for consideration as to whether the call is wanted or not.

The strategy to block calls from numbers that are not identified as personal can be extended to block calls that are not in the contact list of any of the contacts, based on the privacy restrictions described above. Thus, in setting conditions to not only allow just “personal” contacts but also “friends” will let more calls through, but those will be low risk of being unwanted.

The present invention is configurable to add additional ways of designating calls. A contact may be designated in a way to block or not block the call, or share or not share the contact. A “white list” can be created of numbers that are not to be blocked, while a grey list is for calls to go into voice mail, and a black list can be made of numbers to be blocked.

The addition of contact activity can be used to improve the requested results. For example, the activity of particular contact on a list, such as how many calls were made to a contact number and/or when, and how many calls were received from the contact, and time when the calls were made and their duration, all such information can be used to determine if such a number is unwanted and therefore to be blocked.

The actual information can be added to the contact list or retrieved from the Call Detail Records (CDR) available to the particular carrier involved in completing the call.

Artificial intelligence (AI) can be used to improve search and retrieval and result presentation for any of the above scenarios. Screening history can be generated and analyzed, with the analysis being used to determine if a call that passed screening before needs to be screened again, or for some period of time, or for some number of times the number calls.

FIG. 2 in flow chart form describes how in one aspect of the invention calls can be made. At 202, a user makes a call or attempts to get an address. At 204, the called number is searched in personal contacts and public records, and added to a list of contacts. At 206 shareable contacts are added to the list of contacts, based on relations setting, e.g., a private contact is not added if the person who designated the number private does not wish it to be shared. At 208, other data or information can be shared depending on the relations list. And finally, at 210 shareable contacts are used to block calls based on the relations list. In essence, once a user makes additional data entries according to relations and properties, the additional data can be used to block calls, allow calls, and to share other data as needed. The shareability of the contact can be determined by the person whose data is to be shared, thereby allowing only what the user wants to share, to be shared. Any shared information about a caller can be used to block or permit that caller to complete a call.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method of sharing contact information comprising:
adding to each of a plurality of contact lists information indicating, for each entry in each contact list, information indicating a level of shareability of the entry with non-owners of the contact list based on relations of the owner of the contact list with the non-owners, and adding information indicating a relation of the entry with the owner of the contact list;
in response to a request for access to each entry in a contact list by a non-owner of the contact list, granting or restricting access to the contact list based on a relation of the owner to the non-owner requesting access and based on an indicated level of shareability of each entry.

2. The method of claim 1, wherein the information indicating a level of shareability includes information indicating that a contact is a family member, a friend, a public entity or a private entity.

3. The method of claim 2, wherein information indicating a relation includes information indicating that a contact is a family member, a friend or a public entity.

4. The method of claim 1, further comprising blocking, screening or passing a call based on a determination of whether an origination phone number was found in a list of shared contacts.

5. An apparatus for sharing contact information comprising:
means for adding to each of a plurality of contact lists information indicating, for each entry in each contact list, information indicating a level of shareability of the entry with non-owners of the contact list based on relations of the owner of the contact list with the non-owners, and means for adding information indicating a relation of the entry with the owner of the contact list; and
in response to a request for access to each entry in a contact list by a non-owner of the contact list, means for granting or restricting access to the contact list based on a relation of the owner to the non-owner requesting access and based on an indicated level of shareability of each entry.

6. The apparatus of claim 4, wherein the information indicating a level of shareability includes information indicating that a contact is a family member, a friend, a public entity or a private entity.

7. The apparatus of claim 5, wherein information indicating a relation includes information indicating that a contact is a family member, a friend or a public entity.
